(19) United States
(12) Patent Application Publication
(10) Pub. No.: US 2015/0315829 A1
(43) Pub. Date: Nov. 5, 2015

(54) METHOD FOR PRODUCING MOTOR VEHICLE LOCKS BY TARGETED OBLIQUE STAMPING OF THE LOCKING PART LATCH SURFACES

(71) Applicant: KIEKERT AKTIENGESELLSCHAFT, Heiligenhaus, North Rhine-Westphalia (DE)

(72) Inventors: Thorsten Bendel, Oberhausen, North Rhine-Westphalia (DE); Werner Pohle, Dortmund, North Rhine-Westphalia (DE); Thomas Waldmann, Mulheim Ruhr, North Rhine-Westphalia (DE)

(21) Appl. No.: 14/650,616

(22) PCT Filed: Dec. 11, 2013
(86) PCT No.: PCT/DE2013/000768

§ 371 Date: Jun. 25, 2015

(30) Foreign Application Priority Data
Dec. 11, 2012 (DE) 10 2012 024 210.7

(51) Int. Cl. E05B 85/24; E05B 79/10

(52) U.S. Cl. CPC E05B 85/243; E05B 79/10

(57) ABSTRACT

In order to minimize noises occurring between the individual locking parts of a motor vehicle lock, the grooves extending at a defined angle with respect to each other are produced on the locking parts or on the latch surfaces during the production process. The generated grooves then slightly overlap which considerably reduces the sliding friction and the disturbing noises.

### CROSS-REFERENCE TO RELATED APPLICATIONS

This application is the U.S. national stage application of International Patent Application No. PCT/DE2013/000768, filed Dec. 11, 2013, which claims priority of German Application No. 10 2012 024 210.7, filed Dec. 11, 2012, which are both hereby incorporated by reference.

### BACKGROUND

Procedure for the production of motor vehicle locks by purposefully oblique stamping of the locking mechanism ratchet surfaces

The invention relates to a process for the production and assembly of the locking mechanisms of motor vehicle locks and the latch bracket possessing at least one bracket side interacting with the catch, whereby the locking mechanism with vertical or virtually vertical edges and corresponding ratchet surfaces stressed on friction during opening and closure is stamped out and assembled in such a way that the stamping and cutting surface contours are at an angle to one another in the area of the ratchet surfaces. The invention also relates to a latch with the locking mechanism catch with a mounting for a latch bracket and the locking mechanism safety catch securing the catch in the closed state which are stamped or cut out of sheet metal and on the surface structures arising on the vertical or virtually vertical edges demonstrate grooves running at an angle to one another in the installation position in the area of the corresponding ratchet surfaces which rub together.

From DE 10 2010 009 141 A1 it is known to provide for especially developed hanger brackets in order to attain low-noise designs which optimally transfer the forces arising during driving of the motor vehicle.

The outside wall of the bracket side is equipped with a surface structure, especially in the contact area with the catch, which consists of grooves or relevant bars running obliquely to the longitudinal axis of the bracket side. Alongside the relevant design of the bracket side it also known according to this theory to equip the catch in the area of the mounting with an identical or similar surface structure in order to prevent the so-called creaking in particular. The relevant solutions revealed in this step provide for all artificially produced surface structures from bars or grooves which are therefore applied onto the already available surface of the bracket side or also the catch in a separate work process. The work required for such specifically produced grooves and bars is considerable. The solution known from DE 10 2007 060 626 A1 provides for the surface structures being inserted at an angle to one another in the stamping or cutting process that an entry into operation or removal from operation cannot lead to detrimental noise. Friction should also be reduced.

With regard to the angularity it is only determined that the grooves arising as a result of stamping or cutting (surface structures) should run at an angle of >90° to the longitudinal edges and are different. In the manufacture of this in a groove running at a different angle to the longitudinal edge it is also determined that the sheet metal from which the lock part is stamped out is held at an angle to the cutting temple when stamping. This is awkward or difficult to achieve, especially if the grooves produced on the lock parts need to have a different angle which is approximately 90°.

### SUMMARY

The task of the present invention is therefore to create a procedure for the production and installation of motor vehicle locks and relevant motor vehicle locks for which on the one hand the manufacturing costs are considerably lower and on the other hand the operation of the mounted locks is clearly more secure than in the state of the art.

The task is solved procedurally by the locking mechanisms being processed during stamping and/or cutting in such a way that the surface structures arising on the ratchet surfaces cross each other at an angle of 3-20° with retention of a specific overlapping of the grooves produced on interaction during the opening and closing process.

The locking mechanisms are produced in such a way during stamping and/or cutting that they specifically run obliquely to one another at a small angle of 3-20°. This means that when the pawl and the catch grind or rub together both components in this ratchet surface area only touch the grooves namely with a targeted overlap, i.e. they should not overlap overall, only in the areas ensuring uniform operation. This considerably minimises the sliding friction arising, which leads to a very considerable reduction of noise stress, if not to complete prevention. Generally work can take place with customary stamping tools for production of the oblique stamping contour described, because these create sufficient groove heights or depths in their activity, meaning that the minimisation of sliding friction striven towards can be safely attained. It is particularly advantageous that targeted overlapping of the shape can be attained in the targeted specification of the angle that the grooves rubbing one another only touch at two points in each instance. These two-point touches ensure a uniform motion sequence of the two lock surfaces on one another, without causing all too great or uniform friction surfaces or also interlocking of the grooves.

According to an especially appropriate design of the invention it is envisaged that the locking mechanisms are equipped with surface structures by stamping and processing which cross one another during interaction during the opening and closing process at an angle of 3-15°, preferably 3-10° and even more preferably 5-8°, with preservation of a targeted overlapping of the grooves produced. This specifically reduces the friction effect between the two locking mechanisms to the lowest possible.

It is interesting that the fact can be made use of that grooves are produced anyway on the surfaces of the locking mechanisms or on the edges of the locking mechanisms during stamping out, only that now in the invention the grooves are produced in such a way that they yield specific coverage in the two corresponding locking mechanisms.

A further appropriate design envisages that the normal surface structure with straight or virtually straight grooves is inserted into a locking mechanism and into the corresponding locking mechanism a surface structure with accordingly 3-20°, preferably 5-8° oblique grooves. This solution is appropriate because only one of the two locking mechanisms requires special treatment while the other can be produced with straight or virtually straight grooves in accordance with the previous procedure.

It is especially appropriate in the design for only one locking mechanism to have oblique grooves if the pawl is selected as a corresponding locking mechanism with the oblique surface structure. The pawl is the smaller and easier to handle locking mechanism. Consequently, special treatment with the oblique grooves can be achieved here especially well accordingly.

The invention envisages in particular that a 5° angle is set when stamping and/or cutting with a pawl thickness of 4 mm and a distance of the grooves from their surface structure of 0.15 mm-0.30 mm. This means that the catch or its grooves are supported on at least two ridges of the pawl grooves. Consequently, the so-called stick-slip effect can be considerably reduced or completely prevented when the latch is opened and also, if necessary, when closed.

For a targeted production of the oblique surface structure or the relevant grooves, the invention envisages that the stamping tool undergoes a rotary movement when the surface structures demonstrating oblique grooves are produced. Thus, an oblique groove can be securely attained on a locking mechanism which has no straight edges. The same applies accordingly if two locking mechanisms with oblique grooves need to be produced, The rotational movement prevents detrimental forces from occurring. Consequently, the specific insertion of the grooves into the oblique or angular form can be safely attained.

Above, it was noted that a contribution can be made to the specific prevention of creaking noises on the ratchet surfaces between the bracket side and the catch too, whereby the invention complementarily envisages that the catch in the area of the ratchet surfaces corresponding with the bracket side is stamped out and/or mounted with grooves running obliquely to the grooves on the bracket side, that the grooves of the catch and bracket side attain a punctiform overlapping due to the 3-20°, preferably 5-8° angular location of the grooves. The relevant oblique grooves are simpler to produce on the catch than on the bracket side, whereby it must be taken into consideration that relevant grooves are produced anyway during the stamping out of the catch which, in accordance with the invention, then become oblique for the contact area with the bracket side.

A latch which attains lower production costs and which enables safe and low-noise operation has surface structures on the locking mechanisms in the form of grooves in accordance with the solution in accordance with the invention which are applied during stamping or cutting at an angle of 3-20° to one another on the edges of the locking mechanisms. If a thus especially designed pawl or also catch is equipped with a special stamping contour in the area of the latch and here in particular the main ratchet, the noise pollution when opening the latch and also when closing is considerably minimised, because the sliding friction can be reduced to a minimum. This minimisation of sliding friction arises because the two locking mechanisms are no longer fully on one another and accordingly need to be fully moved onto one another. In the area of the ratchet surfaces the two locking mechanisms only come into contact via the stacked grooves in a punctiform area and it prevents recurring interlocking of the grooves on otherwise parallel grooves. This also leads to the safe operation of such a latch as the friction of the two locking mechanisms is only reduced on the punctiform contact areas of the grooves lying on top of one another. As there are at least two such contact points or coverings, a uniform control of the pawl moving on the catch is ensured.

The described little measured contact surface of the touching ratchet surfaces of both locking mechanisms is designed especially beneficially if the grooves of both locking mechanisms are designed at an angle of 3-15°, preferably at 3-10° and even more preferably at an angle of 5-8°. The production of such locking mechanisms is especially cost-effective and attainable with the result striven towards of the oblique grooves, if a locking mechanism, preferably the catch has a surface structure with straight grooves and the corresponding locking mechanisms, preferably the pawl a surface structure with grooves at an angle of 3-20°, preferably 5-8°. By reduction of the angle between the two locking mechanism grooves the number of overlappings is kept low which guarantees uniform control of both locking mechanisms on one another with the lowest possible noise pollution.

Above it was noted that it is appropriate to assign the diagonal grooves to the pawl, whereby it is also envisaged that the grooves on the edge of the pawl demonstrate an angle to the grooves of the catch in the area of the ratchet surface which is securely measured with regard to a duplicate overlapping per groove during interaction during the opening and closure process. In particular, the movement sequence of the two locking mechanisms on one another in the area of their ratchet surfaces is advantageously homogenised, whereby due to the low number of contact points or overlappings the friction can also be minimised at the same time.

The invention is characterised in particular that without an additional noteworthy manufacturing expense a motor vehicle lock and a production process is created in which the catch and the pawl and if necessary also the bracket side are designed in the respective latch area in such a way that the desired low sliding friction and reduction of the noise pollution are attained. The necessary surface structure is designed and formed in the stamping process by the stamping tools in such a way that oblique grooves are present on the edges predominantly on the main ratchet between the locking mechanism. These grooves run at such a slight angle to one another that a sufficient but as low as possible number of overlappings can be realised. The at least two overlappings ensure a uniform movement process of the pawl when it moves on the ratchet surface of the catch. Additional success can be attained if the grooves on the catch in the ratchet area with the bracket side also demonstrate a slight angle, i.e. if in particular the grooves on the catch are designed at an angle of approximately 5-8° to one another.

Further details and advantages of the invention result from the following description of the pertaining sketch, in which a preferred design example is depicted with the necessary details and individual components.

### BRIEF DESCRIPTION OF THE DRAWINGS

FIG. 1 A top view of a motor vehicle lock in the closed state

FIG. 2 A section of the edge of the catch with straight grooves,

FIG. 3 A section of the edge of the pawl with oblique grooves,

FIG. 4 A further top view of the catch,

FIG. 5 A perspective view of the catch and

FIG. 6 An enlarged reproduction with the bracket sides closed into the mounting of the catch

### DETAILED DESCRIPTION OF THE DRAWING

FIG. 1 shows a top view of a motor vehicle lock 1 with the two locking mechanisms 30, 31, whereby the catch 2, which is pivotable on the axle 3, is secured by the pawl 5. The lock bracket 7 with the bracket side 9 is located in the mounting 4 of the catch 2.

The catch 2 is secured via the pawl 5 pivotable around the pawl axis 6, i.e. the motor vehicle lock 1 can only be reopened if the pawl 5 has previously been pivoted away, which is possible via the door handle not reproduced here.

In order to securely encompass the bracket side 9 of the lock bracket 7, the catch 2 is equipped with a relevantly designed mounting 4. This takes into account that the lock bracket 7 and the bracket side 9 are assigned to a car chassis, while the locking mechanism 8 with catch 2 and pawl 5 are assigned to the motor vehicle door.

It is not emphasised in particular that the edges 15, 16 of the catch 2 and the pawl 5 are equipped with a covering 10. The edges 15, 16 are thus covered by such a covering 10 with the exception of the area of the ratchet surfaces 12, 13 and also the contact surface 20 between the catch 2 and the bracket side 9.

On the closed motor vehicle door lock 1 in accordance with FIG. 1 the pawl 5 with its ratchet surface 13 is located close to the ratchet surface 12 of the catch 2. In order to attain a targeted impact of the sliding friction occurring here, a buffer 24 is provided for in FIG. 1 which can be dispensed with completely on the design for the invention. Instead, the pawl 5 and the catch 2 are close to their ratchet surfaces 12, 13. This is possible because the ratchet surface 12 of the catch 2 as usual for a surface structure 14 is equipped with straight grooves, which were created during stamping, while the pawl 5 is equipped with a ratchet surface 13 with a surface structure 11 with an oblique groove. Thus, the main ratchet 22 is specifically and especially equipped against the so-called stick-slip effect, because now the differently formed surface structures 11 and 14 move on one another and no longer lie fully on one another, but only selectively, which has previously been explained.

FIG. 2 now shows the edge 15 of the catch 2 with respectively straight grooves 17, 17′. It is indicated that this ratchet surface 12 equipped with straight grooves 17 of the pawl 5 has overlaps which only permit selective contact of the ratchet surfaces 12, 13.

Supplementary to this, FIG. 3 can be seen where the edge 16 of the pawl 5 is shown which demonstrates oblique grooves 18, 19. These oblique grooves 18, 19 demonstrate an angle 26 to the straight groove 17, which is 5-8°. The overlappings 25, which are indicated with reference signs in FIGS. 2 and 3, thus occur.

FIG. 4 reproduces the pawl 2 which is equipped with different covering thicknesses or differently designed coverings 10. The main ratchet 22 in a catch 2 designed as a normal stamping part 23 is recognisable here in turn. The size of the ratchet surface 12 is specified by means of relevant design while in accordance with FIG. 1 the entire ratchet surface 12 is designed levelly here. It is recognisable in FIG. 1 that both the main ratchet 22 and also the deep base 27 of the mounting 4 is kept free from the cover by a casing 10.

In the perspective representation of the catch 2 after FIG. 5 it is recognisable that the edge 15 specifies a surface which compulsorily gives rise to noises during friction in the area of the ratchet surface 12 with the ratchet surface 13 of the catch 2. For this reason, as explained, the ratchet surface 12 is equipped with a surface structure 14 which has straight grooves 17 while the surface structure 11 has oblique grooves 18, 19. This design is selected accordingly in order to keep the main ratchet 22 especially free of noise.

Finally, FIG. 6 shows a special design in which also in the area of the deep base 27 the contact surfaces 20 are designed in such a way that straight and oblique grooves are also present here. The straight grooves 21 are indicated here on the external circumference of the bracket side 9, while the contact surface 20 on the catch 2 has oblique grooves 17. In this area too, noise minimisation can be specifically attained. The angle between the straight and oblique grooves 17, 18, 19 is preferably 5-8°.

All stated characteristics, including those taken from the sketches alone, are viewed as crucial to the invention alone and jointly.

1. The invention relates to a process for the production and assembly of the locking mechanism of motor vehicle locks and the lock bracket possessing at least one bracket side interacting with the catch, whereby the locking mechanism with vertical or virtually vertical edges and corresponding ratchet surfaces stressed on friction during opening and closure is stamped out and assembled in such a way that the stamping and cutting surface contours are at an angle to one another in the area of the ratchet surfaces, characterised by the fact that the locking mechanisms are processed in such a way during stamping and/or cutting in such a way that the surface structures arising on the ratchet surfaces cross each other at an angle of 3-20° with retention of specific overlapping of the grooves produced on interaction during the opening and closing process.

2. Procedure in accordance with claim 1, characterised by the fact that the locking mechanisms are equipped with surface structures by stamping and processing which cross one another during interaction during the opening and closing process at an angle of 3-15°, preferably 3-10° and even more preferably 5-8°, with retention of specific overlapping of the grooves produced.

3. Procedure in accordance with claim 1, characterised by the fact that the surface structure with straight or virtually straight grooves is inserted into a locking mechanism and into the corresponding locking mechanism a surface structure with accordingly 3-20°, preferably 5-8° oblique grooves.

4. Procedure in accordance with claim 3, characterised by the fact that the pawl is selected as a corresponding locking mechanism with the oblique surface structure.

5. Procedure in accordance with claim 3, characterised by the fact that an angle of 5-8° is set when stamping and/or cutting with a pawl thickness of 4 mm and a distance of the grooves from their surface structure of 0.15 mm-0.30 mm.

6. Procedure in accordance with claim 1, characterised by the fact that the stamping tool used during production of the surface structures demonstrating oblique grooves undergoes a rotary movement.

7. Procedure in accordance with claim 1, characterised by the fact that the catch in the area of the ratchet surface corresponding with the bracket side is stamped out and/or mounted with grooves running obliquely to the grooves on the bracket side in such a way that the grooves of the catch and bracket side form a punctiform covering due to the 3-20°, preferably 5-8° angular position of the grooves.

8. The motor vehicle lock with the locking mechanism catch with a mounting for a lock bracket and the locking mechanism securing the catch in the closed state. Pawl which is stamped or cut out of sheet metal and demonstrate on the vertical or virtually vertical edges arising surface structures with grooves running at angles to one another in the installation position in the area of the corresponding ratchet surfaces exerting friction on one another, characterised by the fact that the surface structures on the locking mechanisms demonstrate grooves which are attached at an angle of 3-20° to one another on the edges of the locking mechanisms when stamping or cutting.

9. Motor vehicle lock in accordance with claim 8, characterised by the fact that the grooves of both locking mechanisms are formed at an angle of 3-15°, preferably at 3-10° and most preferably at an angle of 5-8°.

10. Motor vehicle lock in accordance with claim 8, characterised by the fact that a locking mechanism, preferably the catch has a surface structure with straight grooves and the corresponding locking mechanism, preferably the pawl demonstrates a surface structure with grooves at an angle of 3-20°, preferably 5-8°.

11. Motor vehicle lock in accordance with claim 8, characterised by the fact that the diagonal grooves demonstrate an angle to the grooves of the catch on the edge of the pawl in the area of the ratchet surface which produces a measurement of a duplicate cover per groove during interaction during the opening and closure process.

12. Motor vehicle lock in accordance with claim 8, characterised by the fact that the grooves of both locking mechanisms are formed at an angle of 3-15°.

13. Motor vehicle lock in accordance with claim 8, characterised by the fact that the grooves of both locking mechanisms are formed at an angle of 3-10°.

14. Motor vehicle lock in accordance with claim 13, characterised by the fact that a locking mechanism has a surface structure with straight grooves and the corresponding locking mechanism demonstrates a surface structure with grooves at an angle of 5-8°.

15. Motor vehicle lock in accordance with claim 14, characterised by the fact that the diagonal grooves demonstrate an angle to the grooves of the catch on the edge of the pawl in the area of the ratchet surface which produces a measurement of a duplicate cover per groove during interaction during the opening and closure process.

16. Procedure in accordance with claim 1, characterised by the fact that the locking mechanisms are equipped with surface structures by stamping and processing which cross one another during interaction during the opening and closing process at an angle of 3-15° with retention of specific overlapping of the grooves produced.

17. Procedure in accordance with claim 1, characterised by the fact that the locking mechanisms are equipped with surface structures by stamping and processing which cross one another during interaction during the opening and closing process at an angle of 3-10° with retention of specific overlapping of the grooves produced.

18. Procedure in accordance with claim 1, characterised by the fact that the surface structure with straight or virtually straight grooves is inserted into a locking mechanism and into the corresponding locking mechanism a surface structure with accordingly 3-20° oblique grooves.

19. Procedure in accordance with claim 18, characterised by the fact that the catch in the area of the ratchet surface corresponding with the bracket side is stamped out and/or mounted with grooves running obliquely to the grooves on the bracket side in such a way that the grooves of the catch and bracket side form a punctiform covering due to the 3-20° angular position of the grooves.
